(19) United States
(12) Patent Application Publication
(10) Pub. No.: US 2004/0177505 A1
(43) Pub. Date: Sep. 16, 2004

(54) Method for the production of a forged piston for an internal combustion engine

(75) Inventors: Karlheinz Bing, Remseck (DE); Gerhard Bucher, Ludwigsburg (DE)

Correspondence Address: WILLIAM COLLARD, COLLARD & ROE, P.C., 1077 NORTHERN BOULEVARD, ROSLYN, NY, 11576, US

(73) Assignee: Mahle GmbH

(21) Appl. No.: 10/734,809

(22) Filed: Dec. 12, 2003

(30) Foreign Application Priority Data
Mar. 14, 2003 (DE) 103 11 149.2

(51) Int. Cl. B23P 11/00

(52) U.S. Cl. 29/888.044

(57) ABSTRACT

A method for the production of a forged piston for an internal combustion engine, having a combustion depression provided on the piston head. The piston is formed from a first cylindrical unmachined part having at least one flat face made of oxidation-resistant steel and a second cylindrical unmachined part having at least one flat face made of hot-forgeable steel, with the same diameters. The two unmachined parts are formed to produce a piston blank, by means of forging, causing the combustion depression to be formed from oxidation-resistant steel. The piston blank is subsequently finished via machining to produce a piston ready for installation in the internal combustion engine. Simple and cost-effective production of a piston having a reduced tendency to oxidize at the edge of the depression, and improved protection against wear caused by erosion, is achieved in that the unmachined parts are brought together at their flat faces and aligned with respect to their diameters (d), so that the faces form a minimal projection and a minimal parting. Subsequently, the unmachined parts are fixed in place at the parting by a minimal number of weld points.

### BACKGROUND OF THE INVENTION

1. Field of the Invention

The invention relates to a method for the production of a forged piston for an internal combustion engine, having a combustion depression provided on the piston head. The piston is formed from a first cylindrical unmachined part having at least one flat face made of oxidation-resistant steel and a second cylindrical unmachined part having at least one flat face made of hot-forgeable steel, with the same diameters. The two unmachined parts are formed to produce a piston blank, by means of forging, and subsequently finished via machining to produce a piston ready for installation in the internal combustion engine.

2. The Prior Art

In order to increase the performance of modern internal combustion engines, particularly diesel engines, the compression pressures and thereby the temperatures in the combustion space are constantly being increased. The result of this measure is that after running the engine, oxidation is found on the steel piston having a combustion depression, or on steel piston heads, which oxidation particularly occurs at the edge of the depression, as a function of the operating temperature that was reached. This oxidation can lead to the formation of cracks and thereby to failure of the component. Likewise, material wear at the piston head, along the fuel injection tracks, is also critical, and makes protection against erosion wear necessary. Known solutions for improving this situation are, for example, coating the finished piston with an oxidation-resistant layer along the edge of the depression, by means of plasma-spraying or application welding of more oxidation-resistant materials onto the pre-finished piston.

A method for the production of a piston or piston head for an internal combustion engine is described in International Application No. PCT/DE02/02768, which solves the aforementioned problem in that a ring-shaped recess is worked into the face of an unmachined steel part. This recess is subsequently filled via welding with an oxidation-resistant material. Subsequently, the unmachined part is forged to produce a piston, and afterwards finished to produce a piston ready for installation. The result achieved by the forging, i.e. forming process, is that the oxidation-resistant material comes to rest at the edge of the combustion depression of the piston. However, the relatively large number of process steps is a disadvantage, making the production of such a piston more expensive and ineffective.

A different solution is shown by International Publication No. WO 02/06658 A1, which shows a cylinder-shaped unmachined part made of chromium steel, i.e., an oxidation-resistant steel, connected with a second cylinder-shaped unmachined part consisting of conventional steel (SE 4140), by means of friction welding. These parts are subsequently formed into a piston by means of hot-forging, which piston is subsequently subjected to final finishing. A disadvantage of this process is that the two unmachined parts must be rigidly connected over a certain area, i.e. at their faces. The production method therefore requires a complicated pre-processing step for the production of a piston. In addition, because of the friction welding, a rather sizable degree of welding flash occurs on the circumference, which must be removed before the forging process by lathing or grinding, since the blank joined together in this way cannot be placed into the forging mold and the welding flash material does not permit perfect forming with a resulting good metallic connection.

### SUMMARY OF THE INVENTION

It is therefore an object of the invention to provide a simple and cost-effective production method for a piston having a reduced tendency to oxidize at the edge of the depression, and improved protection against wear caused by erosion.

In the method according to the invention, the piston is formed from a first cylindrical unmachined part having at least one flat face made of oxidation-resistant steel and a second cylindrical unmachined part having at least one flat face made of hot-forgeable steel, with the same diameters. The two unmachined parts are formed to produce a piston blank, by means of forging, causing the combustion depression to be formed from oxidation-resistant steel. The piston blank is subsequently finished via machining to produce a piston ready for installation in the internal combustion engine. To form the piston, the unmachined parts are brought together at their flat faces and are aligned with respect to their diameters (d), so that the faces form a minimal projection and a minimal parting. Subsequently, the unmachined parts are fixed in place at the parting by a minimal number of weld points. Simple and cost-effective production of a piston having a reduced tendency to oxidize at the edge of the depression, and improved protection against wear caused by erosion, is achieved in this way.

With the production method according to the invention, full-area welding of the cylindrical unmachined parts made of steel at their faces is no longer necessary, and the cutting process for removal of the welding flash, which is usually necessary because of the friction welding process that is usually applied, becomes superfluous. The method for the production of a piston becomes more effective, since there is now a free choice of the welding processes that can be used, and it becomes more economical in its implementation, because there is one less processing step.

As a result of the mere fixation of the unmachined parts, by means of a minimal number of weld points distributed over the circumference of the parting that is formed by placing the faces of the two unmachined parts against one another, a bubble-free as well as slag-free metallic bond is produced on the piston blank after forging. This bond is formed by closing only the parting that is formed by laying the faces of the two unmachined parts against one another, by welding from the outside over the entire circumference.

In a preferred embodiment, three weld points are formed, offset from one another on the circumference by an angle of 120 degrees. In another embodiment, the welding is carried out without preheating the unmachined parts. In yet another embodiment, immediately after fixing, the unmachined parts are inductively heated and subsequently forged to produce a piston blank in a heated state. This heating process preferably takes place at a temperature of 1100° C. to 1300° C. The welding can be accomplished via arc welding, laser welding, or electron beam welding.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows schematically, the sequence of the production method according to the invention, in Steps A to D; and

FIG. 2 shows schematically, another variant of the production method according to the invention, in Step A.

### DETAILED DESCRIPTION OF THE PREFERRED EMBODIMENT

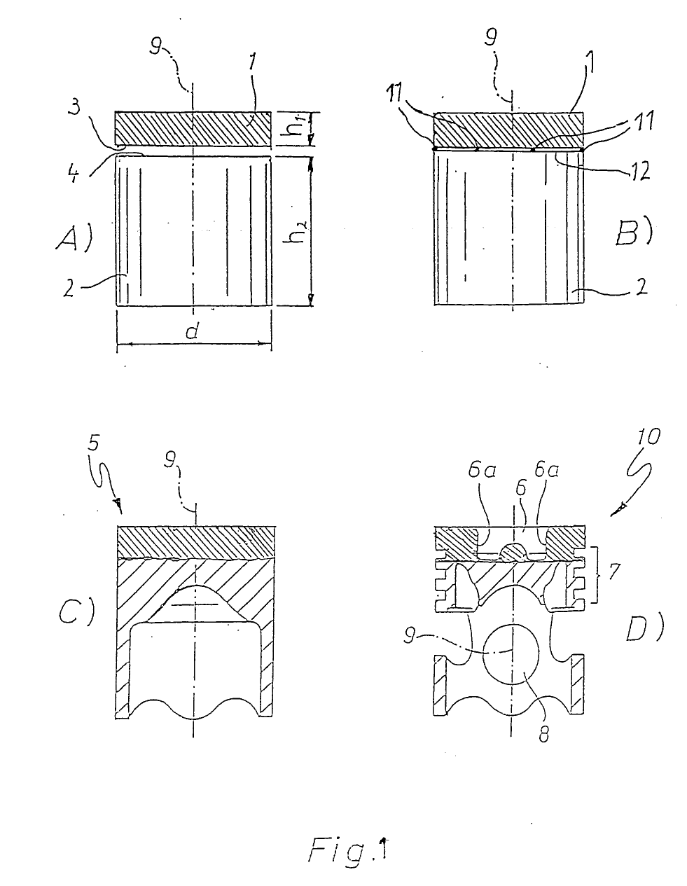

Referring now in detail to the drawings, in FIG. 1, according to method step A), a cylindrical unmachined part made of oxidation-resistant steel, referred to as 1, has a flat face 3 formed at a right angle to its longitudinal axis 9, which face is produced by means of a lathing work step. Unmachined part 1 consists of a material that has improved oxidation-resistance at temperatures above 500° C., such as the steel X45CrSi9, for example, or other suitable steels, or consists of materials based on nickel, cobalt, or titanium. Another cylindrical unmachined part made of hot-forgeable steel, referred to as 2, that preferably consists of a material 42CrMo4 or 38MnSiVS5, also has a flat face 4 formed at a right angle to its longitudinal axis 9. The two unmachined parts possess approximately the same diameter d, in each instance. Fundamentally, it can be determined by way of the height h₁ of unmachined part 1 what piston regions of piston 10, such as the depression edge region 6a, the complete combustion depression 6, or also parts of the ring part 7, are supposed to consist of oxidation-resistant material.

In another method step, the two unmachined parts can be subjected to a cleaning and degreasing process, using known means, in order to achieve grease-free, dust-free, and oxidation-free joining surfaces, particularly faces 3 and 4. In general, a sufficient cleanliness quality is provided by the cutting process used to produce the join surfaces.

In method step B), the unmachined parts 1 and 2 are brought together at their flat faces 3 and 4 by means of suitable holding means (not shown), and aligned with respect to their diameters d, so that faces 3 and 4 form a minimal projection and a minimal parting 12, i.e. an air gap between the faces. Mere fixing in place of the unmachined parts 1 and 2 by means of a minimal number of weld points 11, which reach beyond parting 12 and are arranged distributed over the circumference of the unmachined parts, takes place by means of a welding process, for example arc welding, laser welding, or electron beam welding, or other known connection methods. The fixation can be formed by at least three weld points 11, offset from one another on the circumference by an angle of 120 degrees. The fixation is carried out without preheating the unmachined parts (1, 2).

Forming of unmachined parts 1 and 2, which have been welded to one another on their circumference, to produce a piston blank 5, is carried out by known forging methods, as shown in method step C) of FIG. 1. For this purpose, the unmachined parts, which have been welded to one another, are subjected to inductive heating, whereby the unmachined parts reach a temperature of 1100° C. to 1300° C. Inductive heating assures rapid heating of the unmachined parts that have been fixed in place, and thereby prevents oxidation of the faces in the parting. Forging to produce a piston blank 5 takes place immediately afterward, while still in the heated state.

The actual “welding together” of the unmachined parts 1 and 2 takes place as a result of the forging process, by means of the formation of a join. The oxidation-resistant material, i.e., the unmachined part 1, is formed so that it comes to rest in the region of the resulting depression edge 6a, i.e. the entire combustion depression 6. Local flow of the material as a result of the forging process, into the region of ring part 7, can also not be precluded. During subsequent cooling from the forging heat, the temperature is conducted so that the two steel materials are present in the desired heat treatment state.

Subsequently, finishing of piston blank 5 to produce a piston 10 that can be used in an internal combustion engine, having the desired combustion depression 6, ring part 7, pin hub 8, etc., takes place by machining.

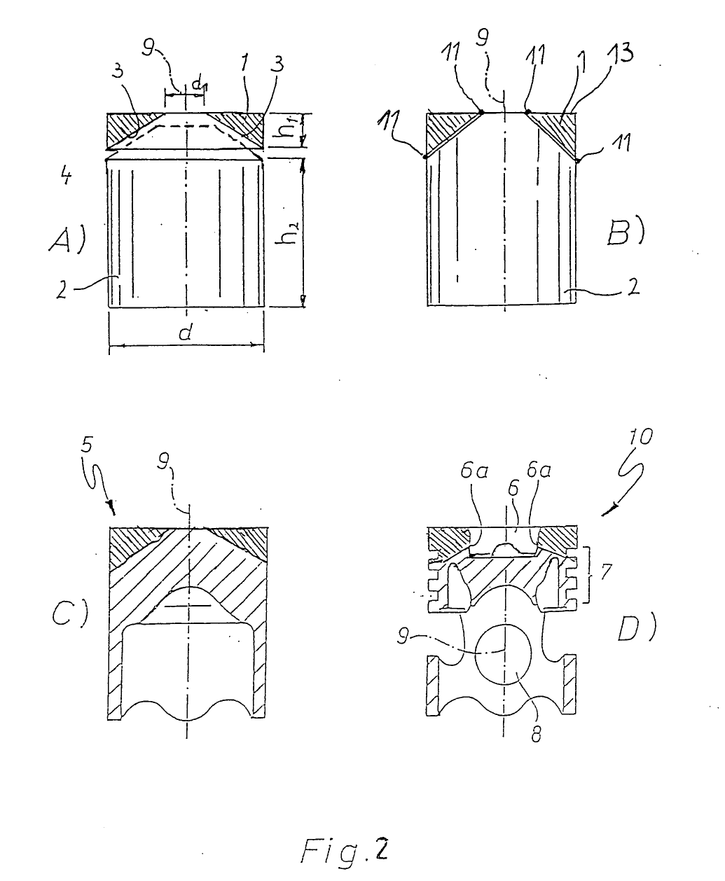

In another exemplary embodiment according to method step A) according to FIG. 2, unmachined part 1 is structured as a ring-shaped part, whose join surface, i.e. face 3 is conical or parallel to the plane of longitudinal axis 9, and against which the joining face or face 4 of unmachined part 2, also conical or plane-parallel, comes to rest so that faces 3 and 4 form a minimal projection and a minimally spaced parting 12 relative to one another. Depending on the inside diameter d₁ and the height h₁ of ring-shaped unmachined part 1, it is determined whether the complete depression edge 6a, only the upper part of the depression edge that reached to the combustion space or, in addition, also part of the ring part 7 consists of the oxidation-resistant material.

Surprisingly, it has been shown that no differences in the structure are evident after the forging process according to method step C), whether weld points 11 are arranged on the circumference and/or on cover surface 13 of unmachined parts 1 and 2, for fixing the unmachined parts in place. The only thing that is necessary is a single fixing in place, in other words either on the circumference or on the cover surface. The subsequent method steps are carried out analogous to the first exemplary embodiment.

It lies within the scope of the invention that the production method according to the invention can also be carried out using unmachined parts 1 and 2.

Accordingly, while only a few embodiments of the present invention have been shown and described, it is obvious that many changes and modifications may be made thereunto without departing from the spirit and scope of the invention.

### REFERENCE SYMBOLS

Cylindrical unmachined part made of oxidation-resistant steel 1

Cylindrical unmachined part made of hot-forgeable steel 2

Flat face of the unmachined part 1 3

Flat face of the unmachined part 2 4

Piston blank 5

Combustion depression 6

Depression edge 6a

Ring part 7

Pin hub 8

Longitudinal axis of parts 1, 2 9

Piston 10

Weld points 11

Parting 12

Cover surface 13

Diameter of the unmachined parts 1, 2 d

Diameter of the unmachined part 1 in a second embodiment d₁

Height of the unmachined parts 1, 2 h_{1, 2}

What is claimed is:

1. A method for the production of a forged piston for an internal combustion engine, having a combustion depression provided on the piston head, comprising the steps of:
forming a piston blank from a first cylindrical unmachined part having at least one flat face made of oxidation-resistant steel and a second cylindrical unmachined part having at least one flat face made of hot-forgeable steel, said parts having same diameters, causing the combustion depression to be formed from oxidation-resistant steel, said step of forming comprising:
(a) bringing the unmachined parts together at their flat faces and aligning said faces with respect to their diameters, so that the flat faces form a minimal projection and a minimal parting; and
(b) fixing the unmachined parts in place at the parting by means of a minimal number of weld points; and
finishing the piston blank via machining to produce a piston ready for installation in the internal combustion engine.

2. A method according to claim 1, wherein the step of fixing is accomplished by forming three weld points, offset from one another on the circumference by an angle of 120 degrees.

3. A method according to claim 2, wherein the step of fixing is carried out without preheating the unmachined parts.

4. A method according to claim 1, wherein immediately after fixing, the unmachined parts are inductively heated and subsequently forged to produce a piston blank in a heated state.

5. A method according to claim 4, wherein the heating process takes place at a temperature of 1100° C. to 1300° C..

6. A method according to claim 1, wherein the step of fixing comprises arc welding, laser welding, or electron beam welding.
